(19) United States
(12) Patent Application Publication
(10) Pub. No.: US 2026/0109022 A1
(43) Pub. Date: Apr. 23, 2026

(54) A WEARABLE ASSISTIVE ROBOT

(71) Applicants: Hamid KHABIRI, Yazd (IR); Alireza MIRBAGHERI, Tehran (IR); Noureddin NAKHOSTIN ANSARI, Tehran (IR); Rouzbeh KAZEMI, Tehran (IR); Seyed Mohammad Mehdi MIRBAGHERI, Tehran (IR)

(72) Inventors: Hamid KHABIRI, Yazd (IR); Alireza MIRBAGHERI, Tehran (IR); Noureddin NAKHOSTIN ANSARI, Tehran (IR); Rouzbeh KAZEMI, Tehran (IR); Seyed Mohammad Mehdi MIRBAGHERI, Tehran (IR)

(21) Appl. No.: 18/855,339

(22) PCT Filed: Jun. 21, 2022
(86) PCT No.: PCT/IB2022/055752

§ 371 Date: Dec. 24, 2025

Related U.S. Application Data
(60) Provisional application No. 63/329,376, filed on Apr. 9, 2022.

(51) Int. Cl. B25J 9/00; B25J 9/10

(52) U.S. Cl. CPC B25J 9/0006; B25J 9/104

(57) ABSTRACT

A hand assistive device includes an index thimble mountable on a tip of an index finger, a middle thimble mountable a tip of a middle finger, a flexor pulley, an extensor pulley, a flexor cable wrapped around the flexor pulley, and an extensor cable wrapped around the extensor pulley. A respective first looped end of each of the flexor cable and the extensor cable coupled to the index thimble and a respective second looped end of each of the flexor cable and the extensor coupled to the middle thimble. An actuator is coupled to the flexor pulley and the extensor pulley to simultaneously actuate a linear motion of the flexor pulley along a translational axis in a first direction and a linear motion of the extensor pulley along the translational axis in an opposing second direction. Such underactuated hand assistive device may allow for grasping objects with various shapes.

### TECHNICAL FIELD

The present disclosure generally relates to robotic exoskeleton systems, particularly to wearable robotic assistive devices. More particularly, the present disclosure relates to a wearable robotic assistive device that may be utilized for assisting the grasping motion of an impaired hand.

### BACKGROUND

Interaction with the environment is greatly facilitated by the hand. The impairment of the hands is common and serious among people who suffer from stroke. Hand motor function may be improved using acute rehabilitation, but the chance of achieving full independence for the impaired hand to perform activities of daily living (ADLs) is slim. Over the past couple of decades, several wearable robotic assistive technologies have been developed to aid patients with impaired hands to independently execute some of the grasping tasks related to ADLs.

The wearable section (glove) may be lightweight so that it may be comfortable for a user, and therefore the actuation unit may not be mounted on top of the hand. Soft exoskeletons employ different principal mechanisms of power transmission to provide the fingers with remote assistance. The cable-driven mechanism is one of the most widely used in soft assistive devices.

Enabling various types of stable grasps and possession of a lightweight structure are the two inexorable conditions any hand assistive device must abide by. But there is an intrinsic contradiction between the two. To implement various types of stable grasp, a fully actuated assistive robot is required with one actuator per degree of freedom (DoF), rendering the high weight and complexity unavoidable. In order to address this challenge, the use of underactuated mechanisms (also known as “self-adaptive mechanisms”) has been proposed. A stable grasp may be attained through such mechanisms by applying a smaller number of actuators than that of fingers. The self-adaptive mechanism may allow fingers to separately touch objects with different shapes while only actuated by one motor.

A number of limitations and drawbacks in previous tendon-driven studies concerning hand assistive devices have been observed, each of which stands as a challenge to developing a feasible hand assistive robot. A first challenge is implementing considerations of glove design like durability, cleanability, and maintenance of structural integrity after repeated actuation. The motion of the wrist has also been another challenge in tendon-driven research. If one end of the cable's outer sheath is fixed on the proximal side of the wrist joint, the cable may play the role of a biarticular muscle, changing the cable path length with the wrist motion. However, instead of restricting the wrist movements with a brace, researchers prefer to fix the end of the outer sheath between the wrist and the metacarpophalangeal joints, despite a reduction in glove compactness. Last but not least is using a proper underactuated mechanism to deliver tension between actuated fingers equally with minimum friction, and another suitable mechanism to prevent agonist/antagonist slacking or positional restriction.

Accordingly, there is a need for a cable-driven device with a design and manufacturing through processes employed to solve or improve the aforementioned challenges and limitations. The hand assistive device, which has a durable and waterproof glove, may flex and extend some fingers to implement a grasp with minimum actuators, while the user may be able to adaptively grasp objects with various shapes.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to an exemplary hand assistive device. An exemplary hand assistive device may include an index thimble that may be configured to receive a tip of an index finger. An exemplary index thimble may include a first embedded flexor guide path and a first embedded extensor guide path. An exemplary hand assistive device may further include a middle thimble that may be configured to receive a tip of a middle finger. An exemplary middle thimble may include a second embedded flexor guide path and a second embedded extensor guide path.

An exemplary hand assistive device may further include a flexor pulley, an extensor pulley, and a flexor cable that may be wrapped around the flexor pulley. A first looped end of an exemplary flexor cable may be coupled to an exemplary index thimble. An exemplary first embedded flexor guide path of an exemplary index thimble may be configured to allow an exemplary flexor cable to pass through lateral sides of a tip of an index finger around a dorsal side of an exemplary tip of an exemplary index finger in response to an exemplary index thimble mounted on an exemplary tip of an exemplary index finger. A second looped end of an exemplary flexor cable may be coupled to an exemplary middle thimble. An exemplary second embedded flexor guide path of the middle thimble may be configured to allow an exemplary flexor cable to pass through lateral sides of a tip of a middle finger around a dorsal side of an exemplary tip of an exemplary middle finger in response to an exemplary middle thimble mounted on an exemplary tip of an exemplary middle finger.

An exemplary hand assistive device may further include an extensor cable that may be wrapped around an exemplary extensor pulley. A first looped end of an exemplary extensor cable may be coupled to an exemplary index thimble. An exemplary first embedded extensor guide path of an exemplary index thimble may be configured to allow an exemplary extensor cable to pass through a dorsal side of a tip of an index finger around a volar side of the tip of an exemplary index finger in response to an exemplary index thimble mounted on an exemplary tip of an exemplary index finger. A second looped end of an exemplary extensor cable may be coupled to an exemplary middle thimble. An exemplary second embedded extensor guide path of an exemplary middle thimble may be configured to allow an exemplary extensor cable to pass through a dorsal side of a tip of a middle finger around a volar side of an exemplary tip of an exemplary middle finger in response to an exemplary middle thimble mounted on an exemplary tip of an exemplary middle finger.

An exemplary hand assistive device may further include an actuator that may be coupled to an exemplary flexor pulley and an exemplary extensor pulley. An exemplary actuator may be configured to simultaneously actuate a linear motion of an exemplary flexor pulley along a translational axis in a first direction and a linear motion of an exemplary extensor pulley along an exemplary translational axis in a second direction. An exemplary first direction opposite an exemplary second direction.

An exemplary hand assistive device may further include a flexible main body that may be configured to conform to and at least partially cover palmar and dorsal sides of a hand. An exemplary flexible main body may further include a first extended portion that may be integrally formed with an exemplary flexible main body. An exemplary first extended portion may be configured to cover a dorsal side of an index finger. An exemplary flexible main body may further include a second extended portion that may be integrally formed with the flexible main body. An exemplary second extended portion may be configured to cover a dorsal side of a middle finger.

An exemplary flexible main body may further include a plurality of flexor guide paths that may be extended within an exemplary flexible main body on a palmer side of an exemplary flexible main body. The plurality of exemplary flexor guide paths may be configured to allow for an exemplary flexor cable to pass along an exemplary palmar side of an exemplary flexible main body.

An exemplary flexible main body may further include a couple of extensor guide paths that may be extended within an exemplary flexible main body on a dorsal side of an exemplary flexible main body. A first extensor guide path of an exemplary couple of extensor guide paths may be configured to allow for an exemplary first end of an exemplary extensor cable to pass along an exemplary dorsal side of an exemplary flexible main body. A second extensor guide path of an exemplary couple of extensor guide paths may be configured to allow for an exemplary second end of an exemplary extensor cable to pass along an exemplary dorsal side of an exemplary flexible main body.

An exemplary index thimble may be attached to or integrally formed with an exemplary first extended portion of an exemplary flexible main body. An exemplary middle thimble may be attached to or integrally formed with an exemplary second extended portion of an exemplary flexible main body.

An exemplary hand assistive device may further include a thumb orthosis. An exemplary thumb orthosis may be a fix structure that may be configured to conform to and embrace a thumb in a fixed position.

An exemplary hand assistive device may further include a couple of index straps that may be mounted on an exemplary first extended portion of an exemplary flexible main body. Each index strap of an exemplary couple of index straps may be configured to be mounted between respective joints of an index finger of a hand in response to an exemplary flexible main body worn on an exemplary hand. Each index strap of an exemplary couple of index straps may include respective lateral flexor guide paths and respective dorsal extensor guide paths. An exemplary hand assistive device may further include a couple of middle straps that may be mounted on an exemplary second extended portion of an exemplary flexible main body. Each middle strap of an exemplary couple of middle straps may be configured to be mounted between respective joints of a middle finger of the hand in response to an exemplary flexible main body worn on an exemplary hand. Each middle strap of an exemplary couple of middle straps may include respective lateral flexor guide paths and respective dorsal extensor guide paths.

Exemplary respective lateral flexor guide paths of an exemplary couple of index straps may be configured to allow for an exemplary first looped end of an exemplary flexor cable to pass along lateral sides of an index finger of a hand in response to an exemplary flexible main body worn on an exemplary hand. Exemplary respective dorsal extensor guide paths of an exemplary couple of index straps may be configured to allow for an exemplary first end of an exemplary extensor cable to pass along a dorsal side of an exemplary index finger of an exemplary hand in response to an exemplary flexible main body worn on an exemplary hand.

Exemplary respective lateral flexor guide paths of an exemplary couple of middle straps may be configured to allow for an exemplary first looped end of an exemplary flexor cable to pass along lateral sides of a middle finger of a hand in response to an exemplary flexible main body worn on an exemplary hand. Exemplary respective dorsal extensor guide paths of an exemplary couple of middle straps may be configured to allow for an exemplary first end of an exemplary extensor cable to pass along a dorsal side of an exemplary middle finger of an exemplary hand in response to an exemplary flexible main body worn on an exemplary hand.

An exemplary flexible main body may further include a plurality of ulnar guide sheaths. An exemplary plurality of ulnar guide sheaths may include a plurality of annular sheaths that may extend along an ulnar zone of a wrist of a hand in response to an exemplary flexible main body worn on an exemplary hand. An exemplary plurality of ulnar guide sheaths may be configured to allow for passage of an exemplary flexor cable and an exemplary extensor cable through an exemplary plurality of ulnar guide sheaths.

An exemplary actuator may include a main shaft and a rotary motor that may be coupled to an exemplary shaft. An exemplary rotary motor may be configured to drive a rotational motion of an exemplary main shaft about a main rotational axis. An exemplary actuator may further include a first rack-and-pinion assembly. An exemplary first rack-and-pinion assembly may include a first rack and a first pinion. An exemplary first pinion may be rotatably mounted on an exemplary main shaft. An exemplary first rack may extend and be moveable along an exemplary translational axis. An exemplary first pinion may be configured to transform a rotational motion of an exemplary main shaft to a linear motion of an exemplary first rack along an exemplary translational axis in an exemplary first direction. An exemplary flexor pulley may be coupled to and movable with an exemplary first rack.

An exemplary actuator may further include a second rack-and-pinion assembly that may include a second rack and a second pinion. An exemplary second pinion may be rotatably mounted on an exemplary main shaft. An exemplary second rack may extend and may be moveable along an exemplary translational axis. An exemplary second pinion may be configured to transform a rotational motion of an exemplary main shaft to a linear motion of an exemplary second rack along an exemplary translational axis in an exemplary second direction. An exemplary extensor pulley may be coupled to and movable with an exemplary second rack. An exemplary first rack and an exemplary second rack may be parallel with each other and mounted opposite each other along an axis mutually perpendicular to an exemplary translational axis and an exemplary main rotational axis. A diameter of an exemplary first pinion may be twice a diameter of an exemplary second pinion.

An exemplary actuator may further include a first coupling mechanism that may be configured to couple an exemplary flexor pulley to an exemplary first rack. An exemplary first coupling mechanism may include a first housing including a first front plate and a first rear plate that may be spaced apart along an exemplary first translational axis. An exemplary first rear plate may be attached to an exemplary first rack. An exemplary first front plate may include a slit that may be configured to allow for passage of an exemplary flexor cable. An exemplary first coupling mechanism may further include a first plurality of connecting rods. Each connecting rod of an exemplary first plurality of connecting rods may extend along an exemplary translational axis. Each connecting rod of an exemplary first plurality of connecting rods may be connected between an exemplary first front plate and an exemplary first rear plate.

An exemplary first coupling mechanism may further include a first fork that may be coupled to an exemplary first plurality of connecting rods by utilizing a first annular plate. An exemplary first annular plate may be slidable on an exemplary first plurality of connecting rods. An exemplary first coupling mechanism may further include a flexor spring that may be mounted between an exemplary first front plate and an exemplary first annular plate. An exemplary flexor pulley may be rotatably mounted on an exemplary first fork.

An exemplary actuator may further include a second coupling mechanism that may be configured to couple an exemplary extensor pulley to an exemplary second rack. An exemplary second coupling mechanism may include a second housing including a second front plate and a second rear plate that may be spaced apart along an exemplary translational axis. An exemplary second rear plate may be attached to an exemplary second rack. An exemplary second front plate may include a slit that may be configured to allow for passage of an exemplary extensor cable. An exemplary second coupling mechanism may further include a second plurality of connecting rods. Each connecting rod of an exemplary second plurality of connecting rods may extend along an exemplary translational axis. Each connecting rod of an exemplary second plurality of connecting rods may be connected between an exemplary second front plate and an exemplary second rear plate.

An exemplary second coupling mechanism may further include a second fork that may be coupled to an exemplary second plurality of connecting rods by utilizing a second annular plate. An exemplary second annular plate may be slidable on an exemplary second plurality of connecting rods. An exemplary first coupling mechanism may further include an extensor spring that may be mounted between an exemplary second front plate and an exemplary second annular plate. An exemplary extensor pulley may be rotatably mounted on an exemplary second fork.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a schematic of a hand assistive device, consistent with one or more exemplary embodiments of the present disclosure;

FIG. 2 illustrates a frontal view of a glove section, consistent with one or more exemplary embodiments of the present disclosure;

FIG. 3 illustrates a dorsal view of a glove section, consistent with one or more exemplary embodiments of the present disclosure;

FIG. 4 illustrates a side-view of a top portion of a glove section, consistent with one or more exemplary embodiments of the present disclosure;

FIG. 5A, FIG. 5B and FIG. 5C illustrate schematic side views of a hand assistive device, consistent with one or more exemplary embodiments of the present disclosure;

FIG. 6A and FIG. 6B illustrate perspective views of a driving unit, consistent with one or more exemplary embodiments of the present disclosure;

FIG. 7 illustrates a top view of an extensor assembly, consistent with one or more exemplary embodiments of the present disclosure; and

FIG. 8 illustrates a perspective view of a flexor assembly, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of a hand assistive device that may aid a patient who suffers from hand impairment. An exemplary hand assistive device may include a wearable assembly that may be worn on a patient's hand and a driving unit that may be configured to actuate flexion and extension of a patient's index and middle fingers by manipulating a Bowden cable system connected between an exemplary driving unit and an exemplary wearable assembly. Such configuration of an exemplary hand assistive device may allow an exemplary patient to grasp objects with different shapes.

An exemplary Bowden cable system of an exemplary hand assistive device may include a flexor cable and an extensor cable that may be coupled to the index and middle fingers of an exemplary patient. In an exemplary embodiment, flexor cable may be looped around respective tips of index and middle fingers by utilizing respective thimbles mounted on respective tips of the index and middle fingers of an exemplary user. An exemplary driving unit may actuate a flexion motion of the index and middle fingers by pulling on an exemplary flexor cable. An exemplary extensor cable may be lopped around respective tips of the index and middle fingers of an exemplary user. An exemplary driving unit may be configured to extend exemplary index and middle fingers by pulling on an exemplary extensor cable.

An exemplary wearable assembly of an exemplary hand assistive device may allow for mounting exemplary thimbles on respective index and middle fingers of a patient and may further allow for guiding extensor and flexor cables to respective tips of exemplary index and middle fingers of a patient. An exemplary wearable assembly may further include a thumb orthosis that may fix an exemplary thumb of a patient in a grasping position. In addition, an exemplary main body of an exemplary wearable assembly may include a porous fabric layer that may be sandwiched between two outer silicon layers. Exemplary cable pathways may be formed within an exemplary main body to prevent exemplary flexor and extensor cables to be affected by wrist movements. Exemplary flexor and extensor cable routes may pass through palmar and dorsal sides of an exemplary hand, and then through the ulnar wrist zone where a neutral axis of wrist flexion/extension is located. Such arrangement of cable routes may further prevent exemplary flexor and extensor cables to be affected by flexion and extension movements of an exemplary wrist.

An exemplary driving unit may include two linear actuation mechanisms that may utilize a single actuator to simultaneously drive translational motions of a flexor pulley and an extensor pulley in opposite directions. An exemplary flexor cable may be wrapped around an exemplary flexor pulley and an exemplary extensor cable may be wrapped around an exemplary extensor pully. An exemplary driving unit may pull on an exemplary flexor cable by linearly moving an exemplary flexor pulley and may pull on an exemplary extensor cable by linearly moving an exemplary extensor pulley. An exemplary driving unit may further include safety measures and measures for preventing cable slacking that will be described.

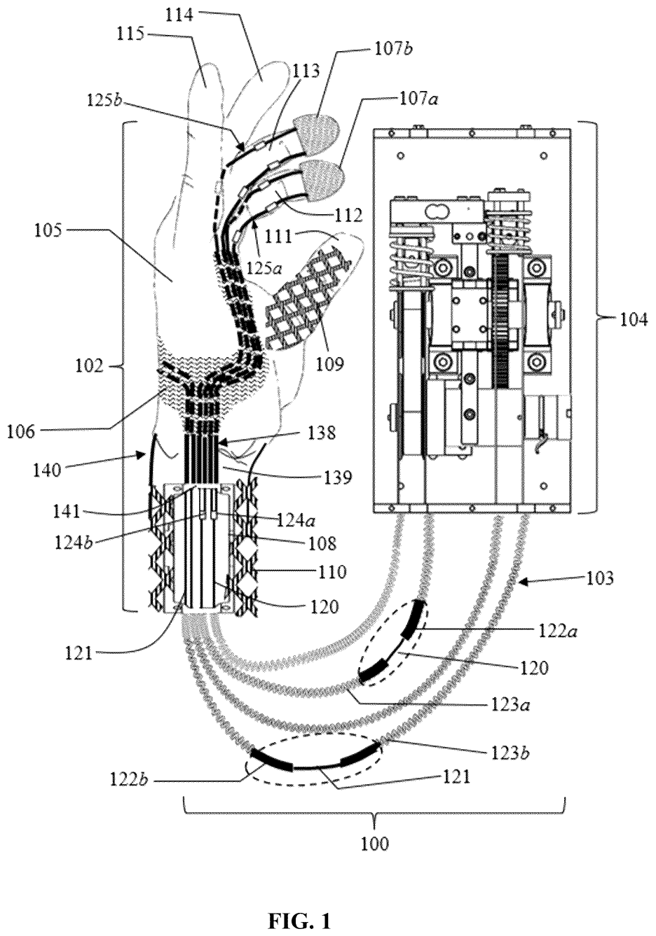

FIG. 1 illustrates a schematic of a hand assistive device 100, consistent with one or more exemplary embodiments of the present disclosure. In an exemplary embodiment, hand assistive device 100 may include a wearable assembly 102 that may be configured as a glove, a Bowden cable system 103, and a driving unit 104 that may be coupled to wearable assembly 102 by utilizing Bowden cable system 103. In an exemplary embodiment, wearable assembly 102 may be worn on a hand 105 of a user and driving unit 104 may send flexion/extension signals to wearable assembly 102 by utilizing Bowden cable system 103 to assist grasping motions of hand 105.

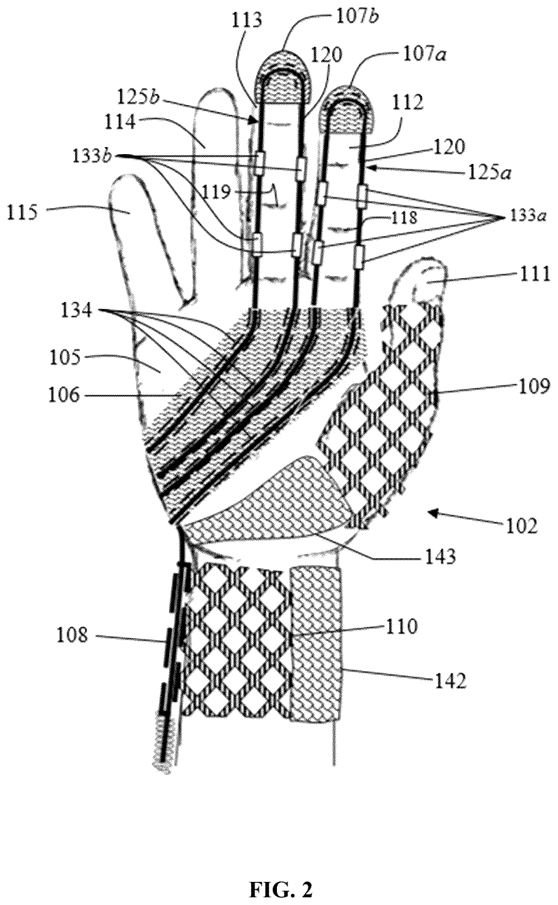

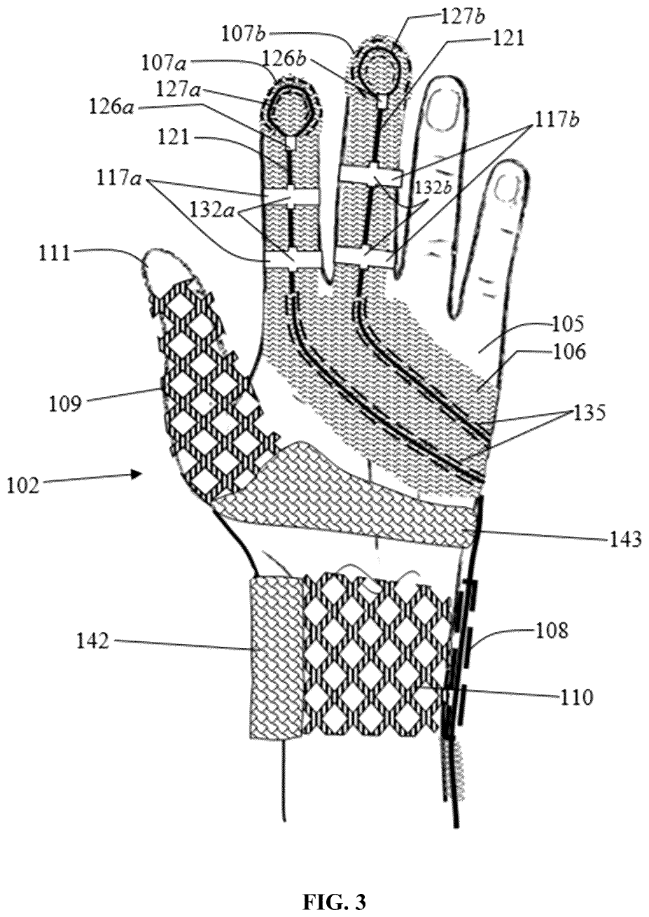

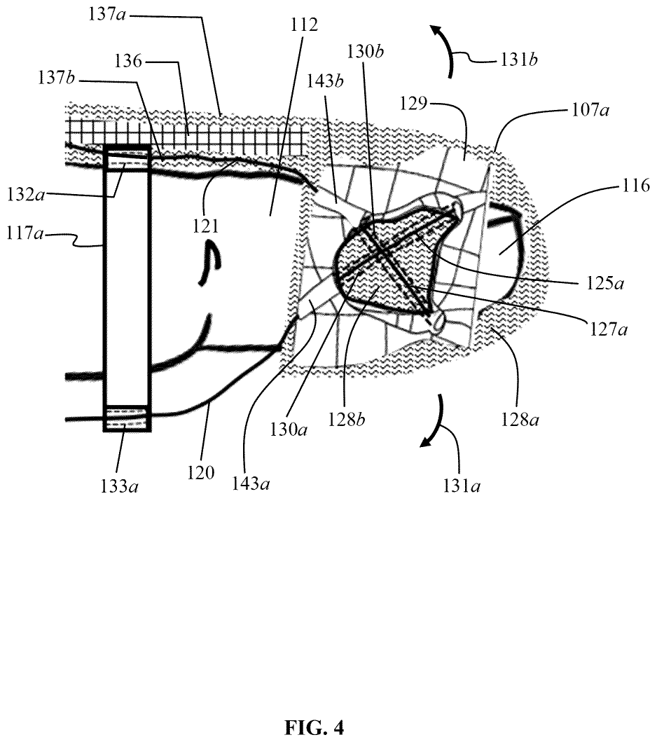

FIG. 2 illustrates a volar side of wearable assembly 102, consistent with one or more exemplary embodiments of the present disclosure. FIG. 3 illustrates a dorsal side of wearable assembly 102, consistent with one or more exemplary embodiments of the present disclosure. FIG. 4 illustrates a sectional side-view of a top portion of wearable assembly 102, consistent with one or more exemplary embodiments of the present disclosure.

In an exemplary embodiment, wearable assembly 102 may include a main body 106, thimbles (107a, 107b), a cable support packet 108, a thumb orthosis 109, and a wrist band 110. As mentioned before, thumb 111, index finger 112, and middle finger 113 may contribute to most of the grasps performed in ADLs, while ring finger 114 and little finger 115 may help the act of grasping as secondary stabilizers. Accordingly, wearable assembly 102 may be configured to allow hand assistive device 100 to flex/extend index finger 112 and middle finger 113.

In an exemplary embodiment, main body 106 may cover dorsal sides of index finger 112 and middle finger 113 but not the palmar sides of index finger 112 and middle finger 113. Such configuration of main body 106 to partially cover index finger 112 and middle finger 113 may prevent sweating, which may help improve a user's comfort. In an exemplary embodiment, a tip 116 of index finger 112 may be covered by thimble 107a and a tip of middle finger 113 may be covered by thimble 107a. In an exemplary embodiment, thimbles (107a, 107b) may be attached to or integrally formed with at least a portion of main body 106 that may cover dorsal sides of index finger 112 and middle finger 113.

In an exemplary embodiment, main body 106 may be made of a material that may satisfy general criteria of cleanability and durability. To this end, in an exemplary embodiment, main body 106 may be made of at least one of a fabric-based material or a silicon-based material. Manufacturing main body 106 out of a fabric may be simple and may allow for other components of wearable assembly 102 to be easily stitched or adhered to main body 106. In addition, a fabric-based main body 106 may not be deformed or torn in repeated use. Specifically, silicon-based materials may have advantages such as being waterproof or easily cleaned, however, silicon-based materials may not be as durable as fabric-based materials in repeated use. In an exemplary embodiment, to harness the advantages of both fabric and silicon, a three-layer composite may be prepared, where a middle layer made of a one-direction stretchable porous fabric may be sandwiched between two outer layers made of silicon. In an exemplary embodiment, two outer layers may be cross-linked through pores of the middle layer.

In an exemplary embodiment, wearable assembly 102 may further include a plurality of straps (117a, 117b) that may be partially embedded within a portion of main body 106 that covers dorsal sides of index finger 112 and middle finger 113. In an exemplary embodiment, each pair of straps may be adapted to be placed around a respective finger, such that each strap of the pair of straps may be positioned between joints of a respective finger. For example, straps 117a may receive index finger 112 within straps 117a, such that straps 117a may be positioned between joints 118 of index finger 112. Similarly, straps 117b may receive middle finger 113 within straps 117b, such that straps 117b may be positioned between joints 119 of middle finger 113. In an exemplary embodiment, such placement of plurality of straps (117a, 117b) on respective index finger 112 and middle finger 113 may allow for guiding a plurality of cables that may be responsible for flexing and extending index finger 112 and middle finger 113, which will be described later.

In an exemplary embodiment, Bowden cable system 103 may include an assembly of cables and sheaths that may allow for transmitting mechanical forces that may be generated by utilizing driving unit 104 to index finger 112 and middle finger 113. In an exemplary embodiment, Bowden cable system 103 may include a flexor cable 120 and an extensor cable 121 that may run from driving unit 104 passing through cable support packet 108 toward tips of index finger 112 and middle finger 113. In an exemplary embodiment, each of flexor cable 120 and extensor cable 121 may include a flexible stranded cable that may be made of multiple smaller wires assembled together. Such cable structure may allow for flexor cable 120 and extensor cable 121 to be strong and flexible and yet have a relatively small diameter.

In an exemplary embodiment, the length of Bowden cable system 103 may be divided into five sections, a first section that may be disposed within and coupled to driving unit 104, a second section that may run between driving unit 104 and cable support packet 108, a third section within cable support packet 108, a fourth section running through main body 106, and a fifth section that may run on index finger 112 and middle finger 113. In an exemplary embodiment, in the first section of Bowden cable system 103, flexor cable 120 and extensor cable 121 may have no cover, in the second section of Bowden cable system 103, flexor cable 120 and extensor cable 121 may be covered by respective outer sheaths (122a, 122b) and further by helical sheaths (123a, 123b), in third section of Bowden cable system 103, flexor cable 120 and extensor cable 121 may not be covered by any sheath, in fourth of Bowden cable system 103, flexor cable 120 and extensor cable 121 may be covered by respective outer sheaths (134, 135), and in the fifth section, flexor cable 120 and extensor cable 121 may not be covered in any sheath between straps (117a, 117b).

In an exemplary embodiment, outer sheaths (122a, 122b) may be made of polytetrafluoroethylene (PTFE) to decrease the overall transmission friction. Such choice of material may allow for flexor cable 120 and extensor cable 121 to have less friction with respective outer sheaths (122a, 122b) while moving within and relative to respective outer sheaths (122a, 122b). In an exemplary embodiment, helical sheaths (123a, 123b) may be made of stainless steel. Such further coverage of flexor cable 120 and extensor cable 121 within helical sheaths (123a, 123b) in the second section of Bowden cable system 103 that runs between driving unit 104 and cable support packet 108 may allow for preventing the deformation of outer sheaths (122a, 122b) under compression.

In an exemplary embodiment, a first end of flexor cable 120 may be looped back and sleeved with a middle portion of flexor cable 120 at a first integration zone 124a within cable support packet 108 forming a first flexor cable loop 125a with two legs running along index finger 112 and looping around the tip of index finger 112 within thimble 107a. In an exemplary embodiment, a second end of flexor cable 120 may be looped back and sleeved with a middle portion of flexor cable 120 at a second integration zone 124b within cable support packet 108 forming a second flexor cable loop 125b with two legs running along middle finger 113 and looping around the tip of middle finger 113 within thimble 107b. In an exemplary embodiment, flexor cable 120 may be extended from first flexor cable loop 125a at first integration zone 124a towards driving unit 104 and after being coupled to driving unit 104 may then loop back towards second flexor cable loop 125b at second integration zone 1640b within cable support packet 108.

In an exemplary embodiment, a first end of extensor cable 121 may be sleeved with extensor cable 120 at a first integration zone 126a within thimble 107a forming a first extensor cable loop 127a around a tip of index finger 112. In an exemplary embodiment, a second end of extensor cable 121 may be sleeved with extensor cable 120 at a second integration zone 126b within thimble 107b forming a second extensor cable loop 127b around a tip of middle finger 113. In an exemplary embodiment, extensor cable 121 may be extended from first extensor cable loop 127a at first integration zone 126a in thimble 107a towards driving unit 104 and after being coupled to driving unit 104 may then loop back towards second extensor cable loop 127b at second integration zone 126b in thimble 107b.

In an exemplary embodiment, thimbles (107a, 107b) may cover respective tips of index finger 112 and middle finger 113. Such coverage of respective tips of index finger 112 and middle finger 113 may allow for creating anchor points for respective first and second flexor cable loops (125a, 125b) and first and second extensor cable loops (127a, 127b) to apply torque on respective finger joints in response to driving unit 104 pulling on either flexor cable 120 or extensor cable 121. In an exemplary embodiment, thimbles (107a, 107b) may be fixedly mounted on respective tips of index finger 112 and middle finger 113 and may be attached to or integrally formed with dorsal side of main body 106.

Referring to FIG. 4, in an exemplary embodiment, each of thimbles (107a, 107b), for example thimble 107a may include an inner silicon layer 128a, a middle layer 129, and an outer silicon layer 128b with a couple of guide tubes (143a, 143b) embedded within middle layer 129 through which sheaths (130a, 130b) may run within middle layer 129 and flexor cable 120 and extensor cable 121 may be coupled with thimble 107a. In an exemplary embodiment, middle layer 129 may be made of polylactic acid (PLA). In an exemplary embodiment, sheaths (130a, 130b) may include a flexion sheath 130a that may loop around and over dorsal side of tip 116 of index finger 112 and an extension sheath 130b that may loop around and below volar side of tip 116 of index finger 112. In other words, first flexor cable loop 125a may pass through flexion sheath 130a running from a first side of thimble 107a passing above a dorsal side of thimble 107a and looping towards a second side of thimble 107a. Such configuration of flexion sheath 130a within thimble 107a may allow for first flexor cable loop 125a to loop from one side of thimble 107a over dorsal side of thimble 107a to the other opposing side of thimble 107a, consequently in response to flexor cable 120 being pulled upon, thimble 107a may force index finger 112 to flex or bend down in a grasping motion in a direction shown by arrow 131a. In an exemplary embodiment, first extensor cable loop 127a may pass through extension sheath 130b looping around volar side of index finger 112 within thimble 107a. Such configuration of extension sheath 130b within thimble 107a may allow for first extensor cable loop 127a to loop around volar side of index finger 112 within thimble 107a, consequently in response to extensor cable 121 being pulled upon, thimble 107a may force index finger 112 to extend in a direction shown by arrow 131b.

In an exemplary embodiment, inner silicon layer 128a may increase the friction between thimble 107a and tip 116 of index finger 112, which may prevent loosening of thimble 107a on tip 116 of index finger 112. In an exemplary embodiment, thimble 107a may further include an outer silicon layer 128b that may cover middle layer 129 to enhance the appearance of thimble 107a. In an exemplary embodiment, middle layer 129 may include a porous layer disposed between inner and outer silicon layers (128a, 128b), where inner and outer silicon layers (128a, 128b) may bond together firmly through pores of middle layer 129. In an exemplary embodiment, such fixation of thimbles (107a, 107b) on respective tips of index finger 112 and middle finger 113 may allow for preventing thimbles (107a, 107b) from being reshaped or torn while being pulled upon by utilizing either flexor cable 120 or extensor cable 121. In an exemplary embodiment, thimble 107b may be structurally similar to thimble 107a. The structure of thimble 107b is not described for simplicity.

As mentioned before, in an exemplary embodiment, plurality of straps (117a, 117b) may be placed on respective index finger 112 and middle finger 113 to guide flexor cable 120 and extensor cable 121 along index finger 112 and middle finger 113. In an exemplary embodiment, each strap of plurality of straps (117a, 117b) may include dorsal guide tubes (132a, 132b) that may be utilized for guiding extensor cable 121 on a dorsal side of index finger 112 and middle finger 113. For example, straps 117a may be placed on index finger 112 and may include dorsal guide tubes 132a to guide extensor cable 121 on a dorsal side of index finger 112. Similarly, straps 117b may be placed on middle finger 113 and may include dorsal guide tubes 132b to guide extensor cable 121 on a dorsal side of middle finger 113.

In an exemplary embodiment, each strap of plurality of straps (117a, 117b) may include side guide tubes (133a, 133b) that may be utilized for guiding flexor cable loops (125a, 125b) on respective lateral sides of index finger 112 and middle finger 113. For example, straps 117a may include side guide tubes 133a that may guide first flexor cable loop 125a on lateral sides of index finger 112. Similarly, straps 117b may include side guide tubes 133b that may guide second flexor cable loop 125b on lateral sides of middle finger 113. In an exemplary embodiment, such guidance of flexor cable 120 along lateral sides of index finger 112 and middle finger 113 instead of running flexor cable 120 in the middle of volar sides of index finger 112 and middle finger 113 may allow for a more comfortable flexion for index finger 112 and middle finger 113 without any obstructions on the volar sides of index finger 112 and middle finger 113.

In an exemplary embodiment, main body 106 may further include four flexor guide sheaths 134 that may pass through palmar side of main body 106. In an exemplary embodiment, flexor guide sheaths 134 may be stitched or adhered to a middle layer 136 of main body 106 such that flexor guide sheaths 134 may not assume any unwanted movements relative to main body 106. In an exemplary embodiment, flexor guide sheaths 134 may be configured to withstand movements of flexor cable 120 and may not slither through main body 106. In an exemplary embodiment, main body 106 may further include two extensor guide sheaths 135 that may pass through dorsal side of main body 106. In an exemplary embodiment, extensor guide sheaths 135 may be stitched or adhered to middle layer 136 of main body 106 such that extensor guide sheaths 135 may not assume any unwanted movements relative to main body 106. In an exemplary embodiment, extensor guide sheaths 135 may be configured to withstand movements of extensor cable 121 and may not slither through main body 106. In an exemplary embodiment, flexor guide sheaths 134 and extensor guide sheaths 135 may be covered by outer silicon layers (137a, 137b) of main body 106.

In an exemplary embodiment, first and second flexor cable loops (125a, 125b) and extensor cable 121 may extend out of main body 106 thorough ulnar guide sheaths 138 towards cable support packet 108. In an exemplary embodiment, ulnar guide sheaths 138 may run along ulnar zone 139 of wrist 140 of hand 105. Such passage of ulnar guide sheaths 138 along ulnar zone 139 may allow for preventing ulnar guide sheaths 138 to be affected by wrist 140 flexion and extension movements, due to the fact that neutral axis of wrist 140 passes through ulnar zone 139. After passing through ulnar zone 139, ulnar guide sheaths 138 may be connected to an output 141 of cable support packet 108.

In an exemplary embodiment, wrist band 110 may include a band that may be tightened around wrist 140 by utilizing Velcro straps 142. In an exemplary embodiment, wrist band 110 may be configured to removably attach cable support packet 108 to wrist 140 by being fastened around cable support packet 108 and wrist 140 by utilizing Velcro straps 142. In an exemplary embodiment, wrist band 110 may further anchor wearable assembly 102 to wrist 140 by being tightened under carpal bones to distribute the pressure and prevent wearable assembly 102 from gliding on wrist skin.

In an exemplary embodiment, thumb orthosis 109 may include a fix structure conforming to thumb 111 and may be configured to fix thumb 111 in a grasping position. Thumb 111 may assume relatively complex movements, however, during a grasping motion, thumb 111 may be positioned opposite other fingers. Here, to reduce the required actuator number, thumb 111 may be fixed in a grasping position by utilizing thumb orthosis 109. In an exemplary embodiment, thumb orthosis 109 may be made of a thermoplastic material that may easily be formed based at least in part on the size and shape of thumb 111. In an exemplary embodiment, thumb orthosis 109 may be made of a porous thermoplastic material for better ventilation and may be fixed around thumb 111 by utilizing a Velcro strap 143.

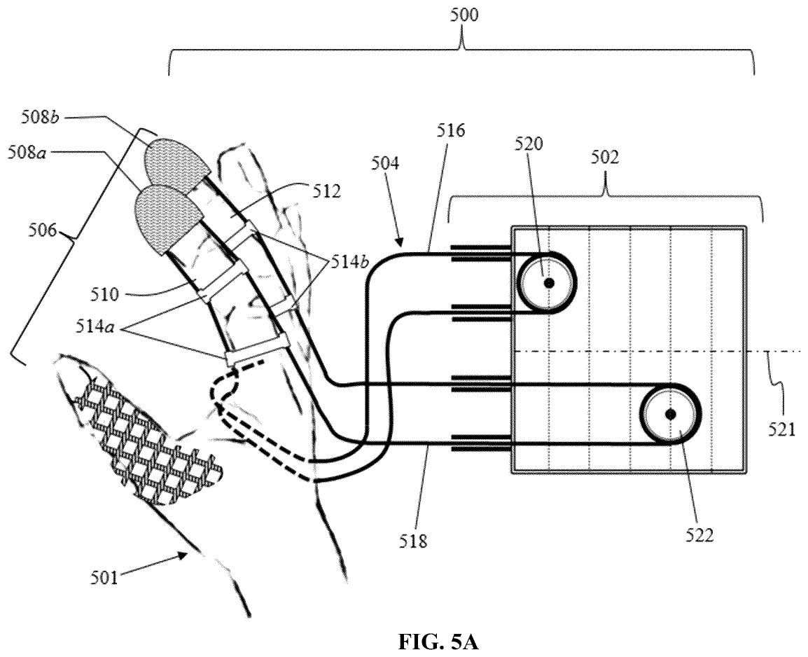

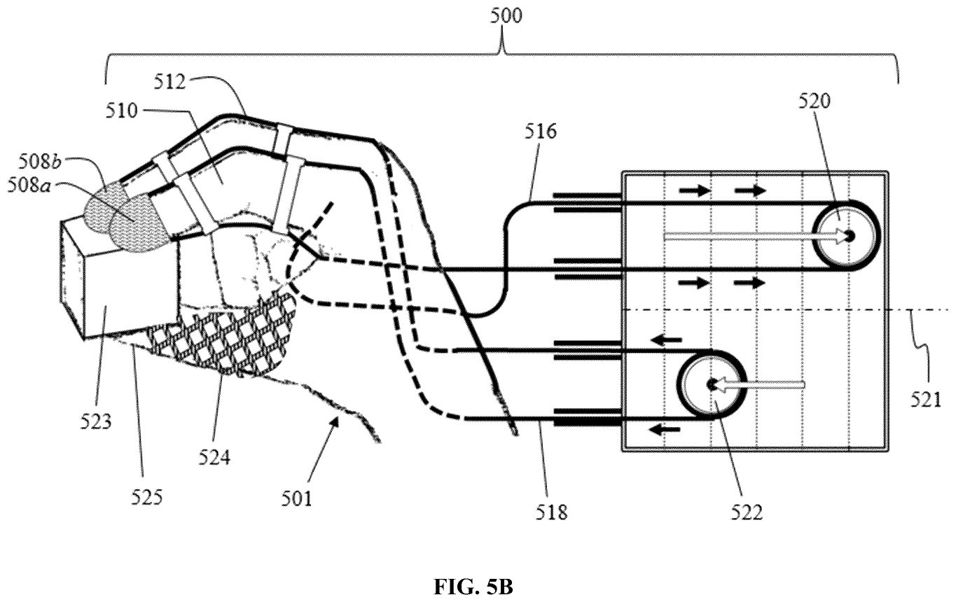

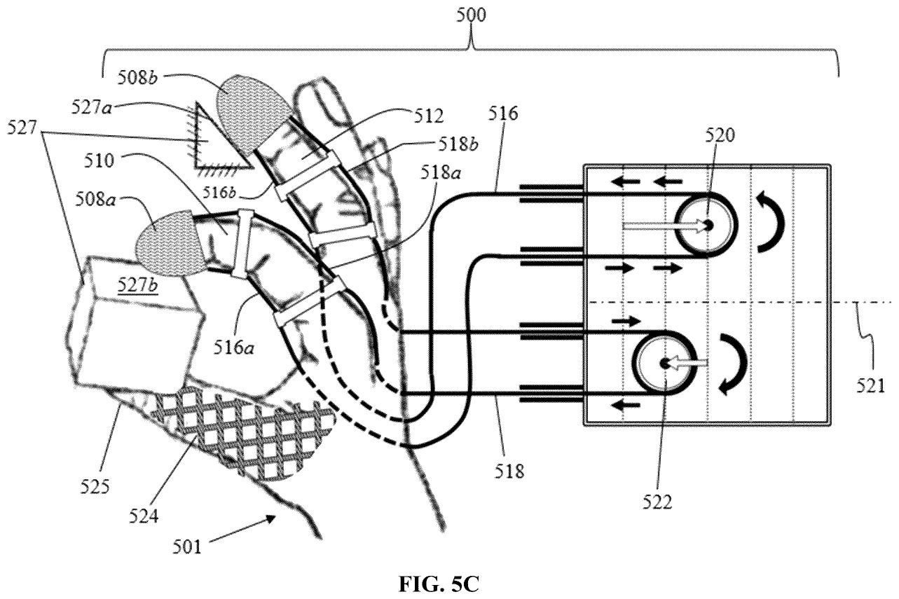

FIGS. 5A-5C illustrate schematic side views of a hand assistive device 500, consistent with one or more exemplary embodiments of the present disclosure. In an exemplary embodiment, hand assistive device 500 may be similar to hand assistive device 100 and may be configured to assist a hand 501 in grasping various objects. In an exemplary embodiment, hand assistive device 500 may include a driving unit 502 that may be similar to driving unit 104, a Bowden cable system 504 that may be similar to Bowden cable system 103, and a wearable assembly 506 that may be similar to wearable assembly 102. For simplicity, guide sheaths, cable support packet, and main body of wearable assembly 506 are not illustrated to allow for a better description of how hand assistive device 500 functions.

In an exemplary embodiment, a wearable assembly 506 may be worn on hand 501 by placing thimbles (508a, 508b) over tips of index finger 510 and middle finger 512 and fastening straps (514a, 514b) around index finger 510 and middle finger 512, such that each respective strap of straps (514a, 514b) may be positioned between respective joints of index finger 510 and middle finger 512. In an exemplary embodiment, such positioning of straps (514a, 514b) in between joints of index finger 510 and middle finger 512 may allow for providing anchor points for Bowden cable system 504 to exert extension and flexion torques on index finger 510 and middle finger 512.

In an exemplary embodiment, Bowden cable system 504 may be similar to Bowden cable system 103 and may include a flexor cable 516 and an extensor cable 518 that may be actuated by utilizing driving unit 502. In an exemplary embodiment, one end of flexor cable 516 may pass through guide sheaths on straps 514a along lateral sides of index finger 510 and may loop around a tip of index finger 510 by passing through guide sheaths within thimble 508a passing over dorsal side of index finger 510. In an exemplary embodiment, the other end of flexor cable 516 may pass through guide sheaths on straps 514b along lateral sides of middle finger 512 and may loop around a tip of middle finger 512 by passing through guide sheaths within thimble 508b passing over dorsal side of middle finger 512. In an exemplary embodiment, loops of flexor cable 516 may pass along lateral sides of index finger 510 and middle finger 512 and around dorsal sides of tips of index finger 510 and middle finger 512 so that when flexor cable 516 is pulled by utilizing driving unit 502, flexor cable 516 may urge index finger 510 and middle finger 512 to bend inwardly. In an exemplary embodiment, driving unit 502 may include a flexor pulley 520 that may be linearly moveable back and forth along a translational axis 521. In an exemplary embodiment, flexor pulley 520 may be configured to allow for flexor cable 516 to wrap around flexor pulley 520. In an exemplary embodiment, driving unit 502 may urge flexor pulley 520 to move back and forth along translational axis 521 to either flex or release flexor cable 516. To this end, driving unit 502 may include an actuating mechanism (not illustrated for simplicity) that may urge flexor pulley 520 move along translational axis 521.

In an exemplary embodiment, one end of extensor cable 518 may pass through guide sheaths on straps 514a along dorsal side of index finger 510 and may loop around a tip of index finger 510 by passing through guide sheaths within thimble 508a passing under volar side of index finger 510. In an exemplary embodiment, the other end of extensor cable 518 may pass through guide sheaths on straps 514b along dorsal side of middle finger 512 and may loop around a tip of middle finger 512 by passing through guide sheaths within thimble 508b passing under volar side of middle finger 512. In an exemplary embodiment, loops of extensor cable 518 may pass over dorsal side of index finger 510 and middle finger 512 and around volar sides of tips of index finger 510 and middle finger 512 so that when extensor cable 518 is pulled by utilizing driving unit 502, extensor cable 518 may urge index finger 510 and middle finger 512 to move upwardly to an open position. In an exemplary embodiment, driving unit 502 may include an extensor pulley 522 that may be linearly moveable back and forth along translational axis 521. In an exemplary embodiment, extensor pulley 522 may be configured to allow for extensor cable 518 to wrap around extensor pulley 522. In an exemplary embodiment, driving unit 502 may urge extensor pulley 522 to move back and forth along translational axis 521 to either extend or release extensor cable 518, as will be discussed.

FIG. 5A shows exemplary fingers of hand 501 in their fully extended position, where hand 501 is open. Here, flexor pulley 520 is fully moved forward to release flexor cable 516 so that no pulling force may be transmitted to thimbles (508a, 508b) by utilizing flexor cable 516. However, extensor pulley 522 is fully pulled backward along translational axis 521 to pull extensor cable 518. Here, pulling force may be transmitted to thimbles (508a, 508b) urging index finger 510 and middle finger 512 to move upwardly to an open position.

FIG. 5B shows how an object 523 with a regular surface may be grasped by hand 501 assisted by hand assistive device 500. Here, flexor pulley 520 is fully pulled backward along translational axis 521 to pull flexor cable 516 so that pulling force may be transmitted to thimbles (508a, 508b) urging index finger 510 and middle finger 512 to bend downward and grasp object 523 with regular surface. As mentioned before, a thumb orthosis 524 similar to thumb orthosis 109 may be utilized to fix thumb 525 in a grasp position, so that when other fingers are bent down, object 523 with regular surface may be grasped by hand 501. In an exemplary embodiment, for grasping object 523 with regular surface, index finger 510 and middle finger 512 must be similarly bent so both ends of flexor cable 516 may be pulled equally. In an exemplary embodiment, as flexor pulley 520 moves backward along translational axis 521, extensor pulley 522 may move forward to release extensor cable 518. In an exemplary embodiment, by moving flexor pulley 520 and extensor pulley 522 back and forth along translational axis 521, object 523 with regular surface may be grasped/released by hand 501. Here, flexor pulley 520 may be moved by a distance twice the distance by which extensor pulley 522 moves along translational axis 521 to actuate a grasping motion.

FIG. 5C shows how an object 527 with an irregular surface may be grasped by hand 501 assisted by hand assistive device 500. Here, in order to grasp the object with irregular surface, index finger 510 and middle finger 512 may be flexed at different extent. To this end, when flexor pulley 520 is being pulled backward along translational axis 521 to pull flexor cable 516, flexor pulley 520 may rotate to allow for flexor cable 516 to rotate around flexor pulley 520. For example, when middle finger 512 engages a surface 527a of object 527 with irregular surface sooner than index finger 510 engaging another surface 527b of object 527, in response to flexor pulley 520 being moved further back flexor cable 516 may force flexor pulley 520 to rotate in a counterclockwise manner so that pulling force may still be exerted on a first loop 518a of flexor cable 516 engaged with index finger 510 to further flex index finger 510, while second loop 518b of flexor cable 516 engaged with middle finger 512 may not exert any pulling force on middle finger 514. In other words, such rotatability of flexor pulley 520 that may allow for flexor cable 516 to rotate over flexor pulley 520 may allow for applying the flexion force to different extents on index finger 510 and middle finger 512. Similarly, when extensor pully 522 is moved forward to release index finger 510 and middle finger 512 to bend down and grasp object 527, in response to middle finger 512 engaging object 527, extensor pully 522 rotates and allows a first loop 518a of extensor cable 518 engaged with index finger 510 to further loosen. In an exemplary embodiment, such rotatability of flexor pulley 520 and extensor pulley 522 may allow for flexor cable 516 and extensor cable 518 to rotate freely around respective flexor pulley 520 and extensor pulley 522, which may further prevent slacking of the cables (516, 518). In an exemplary embodiment, each of flexor pulley 520 and extensor pulley 522 may be fitted with a bearing to allow flexor pulley 520 and extensor pulley 522 to rotate easily in response to flexor cable 516 and extensor cable 518 movement.

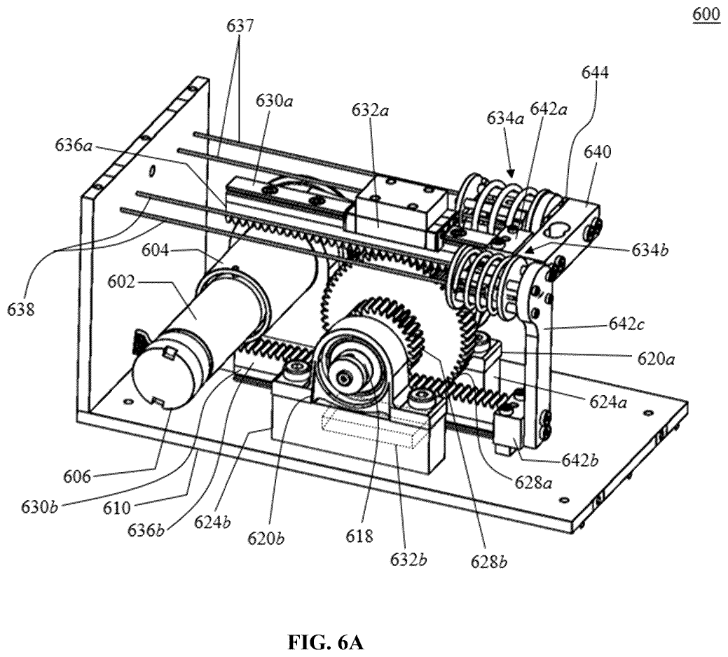

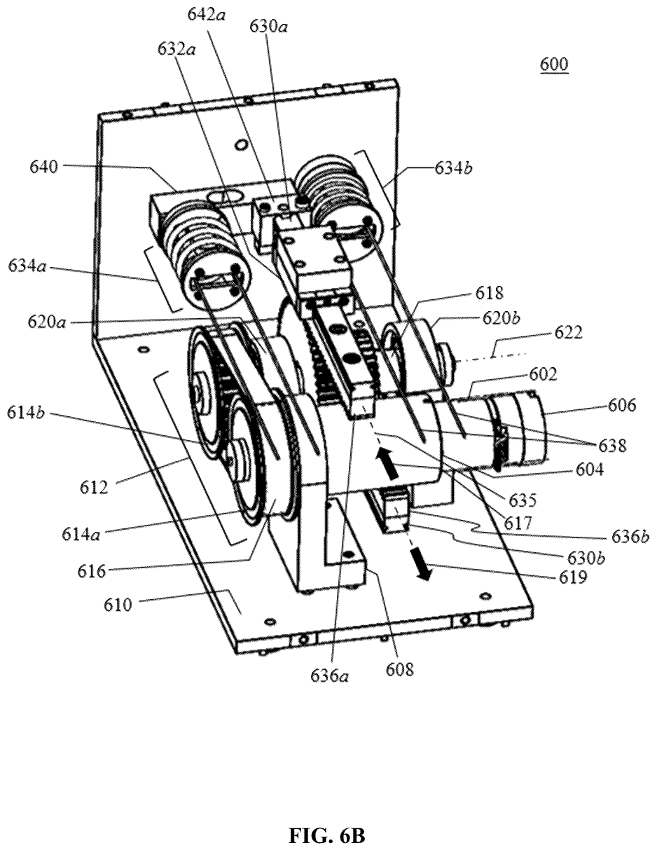

FIGS. 6A-6B illustrate perspective views of a driving unit 600, consistent with one or more exemplary embodiments of the present disclosure. In an exemplary embodiment, driving unit 600 may include a single actuator that may include a rotary motor 602, a planetary gearbox 604 that may be coupled to rotary motor 602, and a rotary encoder 606 that may be coupled to rotary motor 602. In an exemplary embodiment, rotary encoder 606 may be mounted on rotary motor 602 and may be configured to provide accurate displacement measurement and position feedback. In an exemplary embodiment, a flange 608 may be utilized for mounting rotary motor 602 and gearbox 604 on a base plate 610 of driving unit 600. To this end, an upper side of flange 608 may be attached to gearbox 604 and a lower side of flange 608 may be fixed to base plate 610.

In an exemplary embodiment, gearbox 604 may further be coupled to a shaft 618 by utilizing a belt-and-pulley mechanism 612 In an exemplary embodiment, belt-and-pulley mechanism 612 may include two pulleys (614a, 614b) and a timing belt 616 wrapped around pulleys (614a, 614b). In an exemplary embodiment, a first pulley 614a of pulleys (614a, 614b) may be coupled to gearbox 604 and a second pulley 614b of pulleys (614a, 614b) may be coupled to shaft 618. Consequently, in an exemplary embodiment, belt-and-pulley mechanism 612 may be configured to transfer the power output of gearbox 604 to shaft 618. In an exemplary embodiment, shaft 618 may be mounted between a first bearing 620a and a second bearing 620b to constrain the motion of shaft 618 to a rotational motion about a longitudinal axis 622 of shaft 618. In an exemplary embodiment, first bearing 620a may be mounted on base plate 610 by utilizing a first spacer 624a and second bearing 620b may be mounted on base plate 610 by utilizing a second spacer 624b.

In an exemplary embodiment, shaft 618 may further be coupled to a first rack 636a by utilizing a first pinion 628a mounted on shaft 618. In an exemplary embodiment, first pinion 628a may be mounted on and rotatable with shaft 618 and may further mesh with first rack 636a. In an exemplary embodiment, first pinion 628a may be configured to transfer a rotational motion of shaft 618 to first rack 636a. Such rack-and-pinion configuration may allow for transforming a rotational motion of shaft 618 into a translational motion of first rack 636a. In an exemplary embodiment, shaft 618 may further be coupled to a second rack 636b by utilizing a second pinion 628b mounted on shaft 618. In an exemplary embodiment, second pinion 628b may be mounted on and rotatable with shaft 618 and may further mesh with second rack 636b. In an exemplary embodiment, second pinion 628b may be configured to transfer a rotational motion of shaft 618 to second rack 636b. Such rack-and-pinion configuration may allow for transforming a rotational motion of shaft 618 into a translational motion of second rack 636b.

In an exemplary embodiment, first rack 636a and second rack 636b may be parallel and may be mounted opposite each other. Such opposite placement of first rack 636a and second rack 636b may allow for first rack 636a and second rack 636b to assume translational motions in opposite directions in response to a rotational movement of shaft 618. In an exemplary embodiment, first rack 636a may be attached to a first guide rail 630a. In an exemplary embodiment, a first wagon block 632a may be slidably coupled to first guide rail 630a and may further be attached to a top plate of the housing of driving unit 600. Such attachment of first rack 636a to first guide rail 630a and coupling of first guide rail 630a to first wagon block 632a may allow for a stable linear motion of first rack 636a with minimum friction. In an exemplary embodiment, second rack 636b may be attached to a second guide rail 630b. In an exemplary embodiment, a second wagon block 632b may be slidably coupled to second guide rail 630b and may further be attached to baseplate 610. Such attachment of second rack 636b to second guide rail 630b and coupling of second guide rail 630b to second wagon block 632b may allow for a stable linear motion of second rack 636b with minimum friction.

In an exemplary embodiment, driving unit 600 may further include a flexor assembly 634a that may be coupled to flexor cable 637 and an extensor assembly 634b that may be coupled to extensor cable 638. In an exemplary embodiment, flexor assembly 634a may be configured to transfer pulling forces to flexor cable 637 and extensor assembly 634b may be configured to transfer pulling forces to extensor cable 638. In an exemplary embodiment, first rack 636a may be coupled to flexor assembly 634a by utilizing a load cell 640. In an exemplary embodiment, load cell 640 may be attached to first rack 636a by utilizing an interface piece 642a from a first end of load cell 640. In an exemplary embodiment, load cell 640 may be attached to flexor assembly 634a by utilizing a spacer 644. In an exemplary embodiment, such coupling of first rack 636a and flexor assembly 634a by utilizing load cell 640 may allow for a translational motion of first rack 636a to be transferred to flexor assembly 634a and in turn to flexor cable 637. In an exemplary embodiment, load cell 640 may be a force sensor coupled to flexor assembly 634a and may be configured to measure a tension applied to flexor cable 637. In practice, the grasp force of an exemplary hand may be derived from such measured tension.

In an exemplary embodiment, second rack 636b may be coupled to extensor assembly 634b by utilizing interface pieces (642b-c). Such coupling of second rack 636b and extensor assembly 634b may allow for transferring the linear motion of second rack 636b to extensor assembly 634b.

In an exemplary embodiment, flexor cable 637 may be pulled to exert flexion force on exemplary index finger and middle finger of an exemplary hand by utilizing rotary motor 602. To this end, a rotational motion of rotary motor 618 may be transferred to shaft 618 by utilizing gearbox 604 and belt-and-pulley mechanism 612, then rotational motion of shaft 618 may be transferred to first rack 636a by utilizing first pinion 628a. In response to a rotational motion of first pinion 628a, first rack 636a may assume a linear motion that may be transferred to flexor assembly 634a by utilizing load cell 640. This way, flexor assembly 634a may pull flexor cable 637 to exert flexion force on exemplary index finger and middle finger of an exemplary hand. As rotational movement of shaft 618 may urge first rack 636a to move along a translational axis 635, simultaneously rotational motion of shaft 618 may be transferred in an opposite direction to second rack 630b. For example, in response to a counter-clockwise rotation of shaft 618, first rack 636a may assume a translational motion along translational axis 635 in a direction shown by arrow 617, second rack 630b may concurrently assume a translational motion along translational axis 635 in an opposite direction shown by arrow 619.

In an exemplary embodiment, a diameter of first pinion 628a may be twice a diameter of second pinion 628b. For example, first pinion 628a may have a diameter of 60 mm and second pinion 628b may have a diameter of 30 mm. In an exemplary embodiment, such a ratio between the diameter of first pinion 628a and diameter of second pinion 628b may be obtained at least in part based on the extents to which flexor cable 637 and extensor cable 638 must be pulled to effectively allow an exemplary hand to grasp an object. For example, when the amounts of displacement for flexor cable 637 and extensor cable 638 are 4.6 mm and 2.4 mm, respectively for performing a successful grasp, then the translational speed of first rack 636a may be calculated to be twice the translational speed of second rack 636b. In order to reach that speed ratio, a diameter of first pinion 628a may be twice a diameter of second pinion 628b.

Hand size differences or inconstant ratios between flexor and extensor cable displacement during the actuation may occasionally create slack, or even a positional singularity on the device. Safety considerations in hand assistive robots are vital, as they have direct interaction with the human user. For example, any positional singularity within the device's range of motion must strongly be avoided as it is a direct threat to the user's safety. In addition, any slacking that occurs in the extensor cable 638 may lead to an increase in the duration of the desired extension action in driving unit 600.

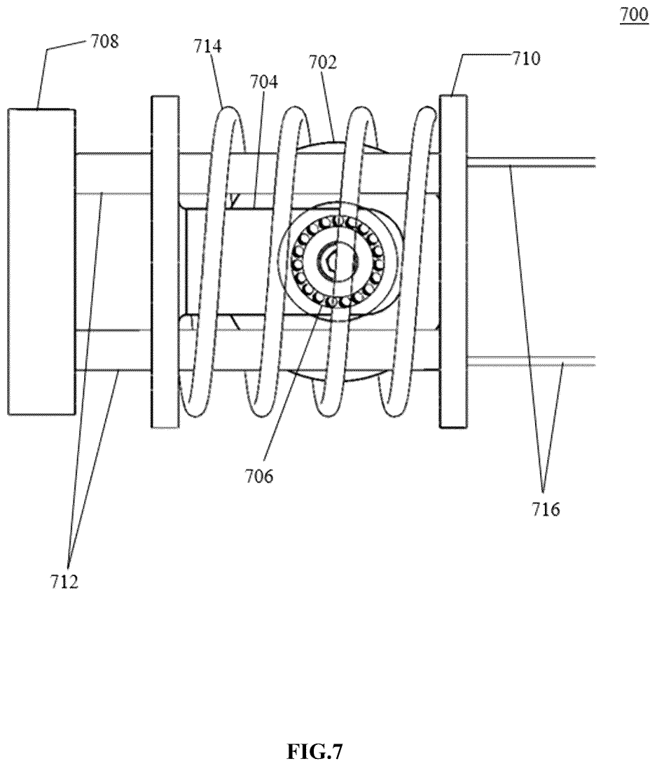

FIG. 7 illustrates a top view of an extensor assembly 700, consistent with one or more exemplary embodiments of the present disclosure. In an exemplary embodiment, extensor assembly 700 may include an extensor pulley 702 similar to extensor pulley 522 that may be mounted on an extensor fork 704. In an exemplary embodiment, extensor pulley 702 may be fitted with an extensor ball bearing 706 that may facilitate a rotational motion of extensor pulley 702 on extensor fork 704. In an exemplary embodiment, extensor pulley 702 may be confined between an interface piece 708 and a front plate 710. In an exemplary embodiment, interface piece 708 and front plate 710 may be attached to each other by utilizing four beams 712. In an exemplary embodiment, extensor assembly 700 may further include an extensor spring 714 that may be mounted between extensor fork 704 and front plate 710.

In an exemplary embodiment, extensor pulley 702 may be moveable within extensor assembly 700 with a linear displacement range of 10 mm. In an exemplary embodiment, an extensor cable 716 similar to extensor cable 638 may be wrapped around extensor pulley 702 while extensor pulley 702 is positioned in a mid-range of its displacement, while extensor spring 714 applies a pre-tension force on extensor cable 716. In practice, responsive to extensor cable 716 requiring more length, extensor pulley 702 moves forward and further compresses extensor spring 714 to free extensor cable 716 to avoid reaching positional singularity. Furthermore, in case of cable slacking, the pre-tension force that may be stored in extensor spring 714 may push extensor pulley 702 back to further tensing extensor cable 716. Consequently, such configuration of extensor assembly 700 with a spring-loaded extensor pulley 702 may address the predicaments of both cable slacking and positional singularity.

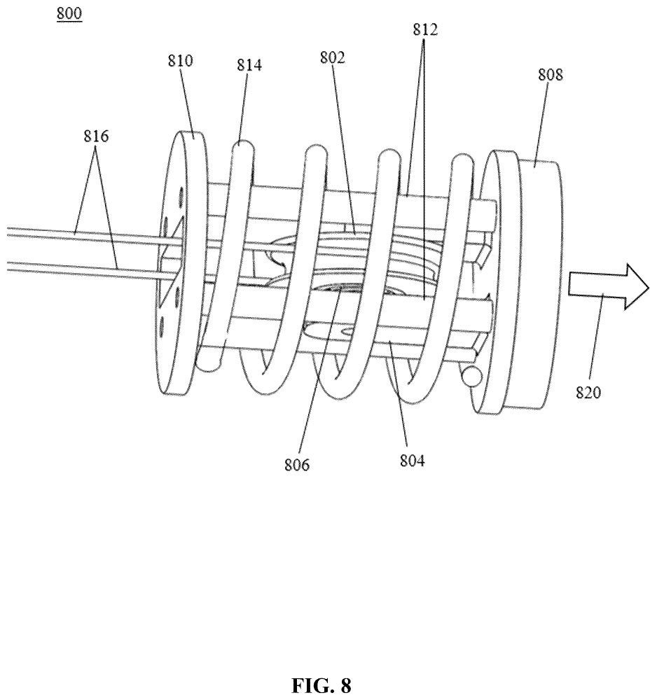

FIG. 8 illustrates a perspective view of a flexor assembly 800, consistent with one or more exemplary embodiments of the present disclosure. In an exemplary embodiment, flexor assembly 800 may include a flexor pulley 802 similar to flexor pulley 520 that may be mounted on a flexor fork 804. In an exemplary embodiment, flexor pulley 802 may be fitted with a flexor ball bearing 806 that may facilitate a rotational motion of flexor pulley 802 on flexor fork 804. In an exemplary embodiment, flexor pulley 802 may be confined between an interface piece 808 and a front plate 810. In an exemplary embodiment, interface piece 808 and front plate 810 may be attached to each other by utilizing four beams 812. In an exemplary embodiment, flexor assembly 800 may further include a flexor spring 814 that may be mounted between flexor fork 804 and front plate 810. In an exemplary embodiment, a flexor cable 816 similar to flexor cable 637 may be wrapped around flexor pulley 802.

In an exemplary embodiment, flexor spring 814 may be mounted between flexor fork 804 and front plate 810 storing a 70 N force. In practice, during a grasp motion, flexor pulley 802 may be linearly moved backward in a direction shown by arrow 820 to pull flexor cable 816 back. In response to being pulled back, flexor cable 816 may exert a reaction force to flexor pulley 802 and flexor fork 804 in a direction opposite the direction shown by arrow 820. In an exemplary embodiment, compressed flexor spring 814 may oppose such reaction force up to 70 N. In an exemplary embodiment, in response to the tension exerted on flexor cable 716 exceeding 70 N, flexor spring 814 may be compressed and flexor pulley 802 may move forward to release flexor cable 716 to ensure the safety of a patient's hand. Specifically, such configuration of flexor spring 814 may prevent the force exerted by flexor cable 816 from increasing abruptly.

The functionality of a hand assistive device such as hand assistive device 100 may further be discussed by assuming that a counter-clockwise torque is generated by rotary motor 602 and gearbox 604. In this example, the pulley 614a which is attached to the output of the gearbox 604 may rotate in a counterclockwise direction and then the timing belt 616 transfers power to the pulley 614b which is attached to shaft 618. Then, shaft 618 may rotate and both pinions 628a-b rotate at the same angular velocity. Here, both bearings 620a-b may prevent any unwanted movement of shaft 618. Then, flexor rack 636a which may mesh with pinion 628a with a 60 mm diameter may move backwardly. Therefore, in an exemplary embodiment, flexor cable 637 may be pulled and index and middle fingers may be flexed. At the same time by moving flexor rack 636a backwardly, extensor rack 636b which may mesh with pinion 628b with a 30 mm diameter may move forwardly. Accordingly, the flexor-to-extensor rack speed ratio is two. So, extensor cable 638 may be released at a speed half the pulling speed of flexor cable 367. Now if the direction of motor 602 is reversed, shaft 618 may rotate in a clockwise direction. Therefore, extensor cable 638 may be pulled and index and middle fingers may be extended while flexor cable 637 is released at a speed double the speed of extensor cable 638. It is worthwhile to mention, load cell 640 may control the grasp force during pulling flexor cable 637 and encoder 606 may control displacements of cables during flexion and extension.

In an exemplary embodiment, four degrees of freedom of flexion/extension of an exemplary index finger and an exemplary middle finger may be actuated by just one single motor, such as rotary motor 602. As mentioned before, flexor cable 637 displacement may be twice the displacement of extensor cable 638.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A hand assistive device, comprising:
an index thimble configured to receive a tip of an index finger, the index thimble comprising a first embedded flexor guide path and a first embedded extensor guide path;
a middle thimble configured to receive a tip of a middle finger, the middle thimble comprising a second embedded flexor guide path and a second embedded extensor guide path;
a flexor pulley;
an extensor pulley;
a flexor cable wrapped around the flexor pulley, a first looped end of the flexor cable coupled to the index thimble, the first embedded flexor guide path of the index thimble configured to allow the flexor cable to pass through lateral sides of a tip of an index finger around a dorsal side of the tip of the index finger in response to the index thimble mounted on the tip of the index finger, a second looped end of the flexor cable coupled to the middle thimble, the second embedded flexor guide path of the middle thimble configured to allow the flexor cable to pass through lateral sides of a tip of a middle finger around a dorsal side of the tip of the middle finger in response to the middle thimble mounted on the tip of the middle finger;
an extensor cable wrapped around the extensor pulley, a first looped end of the extensor cable coupled to the index thimble, the first embedded extensor guide path of the index thimble configured to allow the extensor cable to pass through a dorsal side of a tip of an index finger around a volar side of the tip of the index finger in response to the index thimble mounted on the tip of the index finger, a second looped end of the extensor cable coupled to the middle thimble, the second embedded extensor guide path of the middle thimble configured to allow the extensor cable to pass through a dorsal side of a tip of a middle finger around a volar side of the tip of the middle finger in response to the middle thimble mounted on the tip of the middle finger; and
an actuator coupled to the flexor pulley and the extensor pulley, the actuator configured to simultaneously actuate a linear motion of the flexor pulley along a translational axis in a first direction and a linear motion of the extensor pulley along the translational axis in a second direction, the first direction opposite the second direction.

2. The device of claim 1, further comprising a flexible main body configured to conform to and at least partially cover palmar and dorsal sides of a hand, the flexible main body further comprising a first extended portion integrally formed with the flexible main body, the first extended portion configured to cover a dorsal side of an index finger and a second extended portion integrally formed with the flexible main body, the second extended portion configured to cover a dorsal side of a middle finger.

3. The device of claim 2, wherein the flexible main body further comprises a plurality of flexor guide paths extended within the flexible main body on a palmer side of the flexible main body, the plurality of flexor guide paths configured to allow for the flexor cable to pass along the palmar side of the flexible main body.

4. The device of claim 3, wherein the flexible main body further comprises a couple of extensor guide paths extended within the flexible main body on a dorsal side of the flexible main body, a first extensor guide path of the couple of extensor guide paths configured to allow for the first end of the extensor cable to pass along the dorsal side of the flexible main body, and a second extensor guide path of the couple of extensor guide paths configured to allow for the second end of the extensor cable to pass along the dorsal side of the flexible main body.

5. The device of claim 2, wherein the index thimble attached to or integrally formed with the first extended portion of the flexible main body.

6. The device of claim 3, wherein the middle thimble attached to or integrally formed with the second extended portion of the flexible main body.

7. The device of claim 4, further comprising a thumb orthosis comprising a fix structure configured to conform to and embrace a thumb in a fixed position.

8. The device of claim 7, further comprising:
a couple of index straps mounted on the first extended portion of the flexible main body, each index strap of the couple of index straps configured to be mounted between respective joints of an index finger of a hand in response to the flexible main body worn on the hand, each index strap of the couple of index straps comprising respective lateral flexor guide paths and respective dorsal extensor guide paths; and
a couple of middle straps mounted on the second extended portion of the flexible main body, each middle strap of the couple of middle straps configured to be mounted between respective joints of a middle finger of the hand in response to the flexible main body worn on the hand, each middle strap of the couple of middle straps comprising respective lateral flexor guide paths and respective dorsal extensor guide paths.

9. The device of claim 8, wherein the respective lateral flexor guide paths of the couple of index straps configured to allow for the first looped end of the flexor cable to pass along lateral sides of an index finger of a hand in response to the flexible main body worn on the hand, and wherein the respective dorsal extensor guide paths of the couple of index straps configured to allow for the first end of the extensor cable to pass along a dorsal side of the index finger of the hand in response to the flexible main body worn on the hand.

10. The device of claim 9, wherein the respective lateral flexor guide paths of the couple of middle straps configured to allow for the first looped end of the flexor cable to pass along lateral sides of a middle finger of a hand in response to the flexible main body worn on the hand, and wherein the respective dorsal extensor guide paths of the couple of middle straps configured to allow for the first end of the extensor cable to pass along a dorsal side of the middle finger of the hand in response to the flexible main body worn on the hand.

11. The device of claim 10, wherein the flexible main body further comprises a plurality of ulnar guide sheaths, the plurality of ulnar guide sheaths comprising a plurality of annular sheaths extended along an ulnar zone of a wrist of a hand in response to the flexible main body worn on the hand, the plurality of ulnar guide sheaths configured to allow for passage of the flexor cable and the extensor cable through the plurality of ulnar guide sheaths.

12. The device of claim 11, wherein the actuator comprises:
a main shaft;
a rotary motor coupled o the shaft, the rotary motor configured to drive a rotational motion of the main shaft about a main rotational axis;
a first rack-and-pinion assembly comprising a first rack and a first pinion, the first pinion rotatably mounted on the main shaft, the first rack extended and moveable along the translational axis, the first pinion configured to transform a rotational motion of the main shaft to a linear motion of the first rack along the translational axis in the first direction, the flexor pulley coupled to and movable with the first rack;
a second rack-and-pinion assembly comprising a second rack and a second pinion, the second pinion rotatably mounted on the main shaft, the second rack extended and moveable along the translational axis, the second pinion configured to transform a rotational motion of the main shaft to a linear motion of the second rack along the translational axis in the second direction, the extensor pulley coupled to and movable with the second rack,
wherein the first rack and the second rack are parallel with each other and mounted opposite each other along an axis mutually perpendicular to the translational axis and the main rotational axis.

13. The device of claim 11, wherein a diameter of the first pinion is twice a diameter of the second pinion.

14. The device of claim 13, further comprising a first coupling mechanism configured to couple the flexor pulley to the first rack, the first coupling mechanism comprising:
a first housing comprising a first front plate and a first rear plate spaced apart along the first translational axis, the first rear plate attached to the first rack, the first front plate comprising a slit configured to allow for passage of the flexor cable;
a first plurality of connecting rods, each connecting rod of the first plurality of connecting rods extended along the translational axis, each connecting rod of the first plurality of connecting rods connected between the first front plate and the first rear plate;
a first fork coupled to the first plurality of connecting rods by utilizing a first annular plate, the first annular plate slidable on the first plurality of connecting rods; and
a flexor spring mounted between the first front plate and the first annular plate,
wherein the flexor pulley rotatably mounted on the first fork.

15. The device of claim 14, further comprising a second coupling mechanism configured to couple the extensor pulley to the second rack, the second coupling mechanism comprising:
a second housing comprising a second front plate and a second rear plate spaced apart along the first translational axis, the second rear plate attached to the second rack, the second front plate comprising a slit configured to allow for passage of the extensor cable;
a second plurality of connecting rods, each connecting rod of the second plurality of connecting rods extended along the translational axis, each connecting rod of the second plurality of connecting rods connected between the second front plate and the second rear plate;
a second fork coupled to the second plurality of connecting rods by utilizing a second annular plate, the second annular plate slidable on the second plurality of connecting rods; and
an extensor spring mounted between the second front plate and the second annular plate,
wherein the extensor pulley rotatably mounted on the second fork.
